(19) United States
(12) Patent Application Publication
(10) Pub. No.: US 2005/0077716 A1
(43) Pub. Date: Apr. 14, 2005

(54) Steering column energy absorber

(76) Inventors: Jesus Raul Garcia Urista, Chih (MX); Antonio Reyes, El Paso, TX (US); Francisco Cortes, Chih (MX)

Correspondence Address: HOWARD & HOWARD ATTORNEYS, P.C., THE PINEHURST OFFICE CENTER, SUITE 101, 39400 WOODWARD AVENUE, BLOOMFIELD HILLS, MI, 48304-5151, US

(21) Appl. No.: 10/959,889

(22) Filed: Oct. 6, 2004

Related U.S. Application Data
(60) Provisional application No. 60/509,442, filed on Oct. 8, 2003.
(60) Provisional application No. 60/534,209, filed on Jan. 5, 2004.

(51) Int. Cl. B62D 1/11

(52) U.S. Cl. 280/777

(57) ABSTRACT

The invention an apparatus including a shaft member having a first end. The apparatus also includes a sleeve member having a first opening and an inner surface defining a cavity. The shaft member is slidably received in the first opening. The first end moves along a path extending in the cavity. The apparatus also includes at least one deformable member extending radially inwardly from the inner surface. The apparatus also includes an impact member associated with the first end. The impact member deforms the at least one deformable member during movement of the first end along the path to absorb energy associated with movement of the shaft member.

### CROSS REFERENCE TO RELATED APPLICATIONS

This application claims the benefit of U.S. provisional patent application Ser. No. 60/509,442 for a STEERING COLUMN WITH CUSTOMIZABLE ENERGY ABSORPTION DEVICE, filed on Oct. 8, 2003, and of U.S. provisional patent application Ser. No. 60/534,209 for a STEERING COLUMN WITH CUSTOMIZABLE ENERGY ABSORPTION DEVICE, filed on Jan. 5, 2004, which are hereby incorporated by reference in their entireties. This claim is made under 35 U.S.C. § 119(e); 37 C.F.R. § 1.78; and 65 Fed. Reg. 50093.

### FIELD OF THE INVENTION

The invention relates to a device for absorbing energy associated with the collapse of a vehicle steering column.

### BACKGROUND OF THE INVENTION

Requirements vary on constraints applied to energy absorption systems incorporated in collapsible steering columns for vehicles. Because these requirements vary, it is difficult to determine an energy absorption profile required for a given vehicle in a given jurisdiction. Therefore, it has been difficult to meet these different requirements with a single steering column assembly.

U.S. Pat. No. 4,274,299 to Jones discloses a steering column that has an upper shaft and a lower shaft with an intermediate collapsible tubular member in torque transmitting engagement with the upper and lower shaft sections. The collapsible tubular member is a corrugated metal tube that is connected by welds to the upper and lower shafts. A compressive force applied to the lower shaft section is transmitted to the corrugated metal tube. The corrugated metal tube absorbs the energy transmitted from the compressive force as it deforms. Thus, the corrugated metal tube absorbs some of the energy of the applied compressive force while allowing axial deformation of the steering column assembly.

A problem associated with energy absorbing devices as described in U.S. Pat. No. 4,274,299 to Jones is that the behavior of the corrugated metal tube is not consistent once the corrugated metal tube begins to yield. It would therefore be beneficial to have an energy absorption device attached to a steering column assembly that has a pre-determined axial load performance profile. It would also be beneficial if energy absorption device is customizable to meet the different requirements of various vehicles in differing countries.

### SUMMARY OF THE INVENTION AND ADVANTAGES

The invention an apparatus including a shaft member having a first end. The apparatus also includes a sleeve member having a first opening and an inner surface defining a cavity. The shaft member is slidably received in the first opening. The first end moves along a path extending in the cavity. The apparatus also includes at least one deformable member extending radially inwardly from the inner surface. The apparatus also includes an impact member associated with the first end. The impact member deforms the at least one deformable member during movement of the first end along the path to absorb energy associated with movement of the shaft member.

The invention allows energy absorbing characteristics to be tuned as desired. Also, the invention can provide controlled energy absorption over the length of travel of the impact member. Also, the invention can reduce the cost of the energy absorbing structure.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of an intermediate shaft assembly according to a first exemplary embodiment of the invention;

FIG. 2 is a longitudinal cross-sectional view of the intermediate shaft assembly shown in FIG. 1;

FIG. 3 is a detail view of an energy absorbing portion of the intermediate shaft assembly shown in FIGS. 1 and 2;

FIG. 4 is a cross-sectional view taken along section lines 4-4 in FIG. 1;

FIG. 5 is a side view of an impact member of the intermediate shaft assembly shown in FIGS. 1 and 2;

FIG. 6 is a longitudinal cross-sectional view of an outer shaft according to a second exemplary embodiment of the invention;

FIG. 7 is a cross-sectional view taken along section lines 7-7 in FIG. 6;

FIG. 8 is a perspective view of the outer shaft shown in cross-section in FIG. 6;

FIG. 9 is a front view of the outer shaft shown in cross-section in FIG. 6;

FIG. 10 is a longitudinal cross-sectional view of an outer shaft according to a third exemplary embodiment of the invention;

FIG. 11 is a cross-sectional view taken along section lines 11-11 in FIG. 10;

FIG. 12 is a perspective view of the outer shaft shown in cross-section in FIG. 10;

FIG. 13 is a front view of the outer shaft shown in cross-section in FIG. 10;

FIG. 14 is a longitudinal cross-sectional view of an outer shaft according to a fourth exemplary embodiment of the invention;

FIG. 15 is a cross-sectional view taken along section lines 15-15 in FIG. 14;

FIG. 16 is a perspective view of the outer shaft shown in cross-section in FIG. 14;

FIG. 17 is a front view of the outer shaft shown in cross-section in FIG. 14;

FIG. 18 is a longitudinal cross-sectional view of an outer shaft according to a fifth exemplary embodiment of the invention;

FIG. 19 is a cross-sectional view taken along section lines 19-19 in FIG. 18;

FIG. 20 is a perspective view of the outer shaft shown in cross-section in FIG. 18;

FIG. 21 is a front view of the outer shaft shown in cross-section in FIG. 18;

FIG. 22 is a front view of a plate for assembly to an outer shaft according to a sixth exemplary embodiment of the invention;

FIG. 23 is a perspective view of the plate shown in FIG. 22;

FIG. 24 is a front view of the plate shown in FIGS. 22 and 23 assembly to an outer shaft according to a sixth exemplary embodiment of the invention;

FIG. 25 is a cross-sectional view taken along section lines 25-25 in FIG. 24;

FIG. 26 is a perspective view of an outer shaft according to a seventh exemplary embodiment of the invention;

FIG. 27 is a perspective view of a deformable insert for forming a plate engageable with the outer shaft shown in FIG. 26;

FIG. 28 is a top view of the deformable insert shown in FIG. 27;

FIG. 29 is a front view of the deformable insert shown in FIGS. 27 and 28;

FIG. 30 is a front view of the deformable insert shown in FIGS. 27-29 being deformed for engagement with the outer shaft shown in FIG. 26;

FIG. 31 is a cross-sectional view taken along section lines 31-31 in FIG. 26; and

FIG. 32 is a perspective view of an impact member according to an eighth exemplary embodiment of the invention.

### DETAILED DESCRIPTION OF THE PREFERRED EMBODIMENT

A plurality of different embodiments of the invention are shown in the Figures of the application. Similar features are shown in the various embodiments of the invention. Generally, similar features have been numbered with a common two-digit reference numeral and have been differentiated by a third digit placed before the two common digits. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

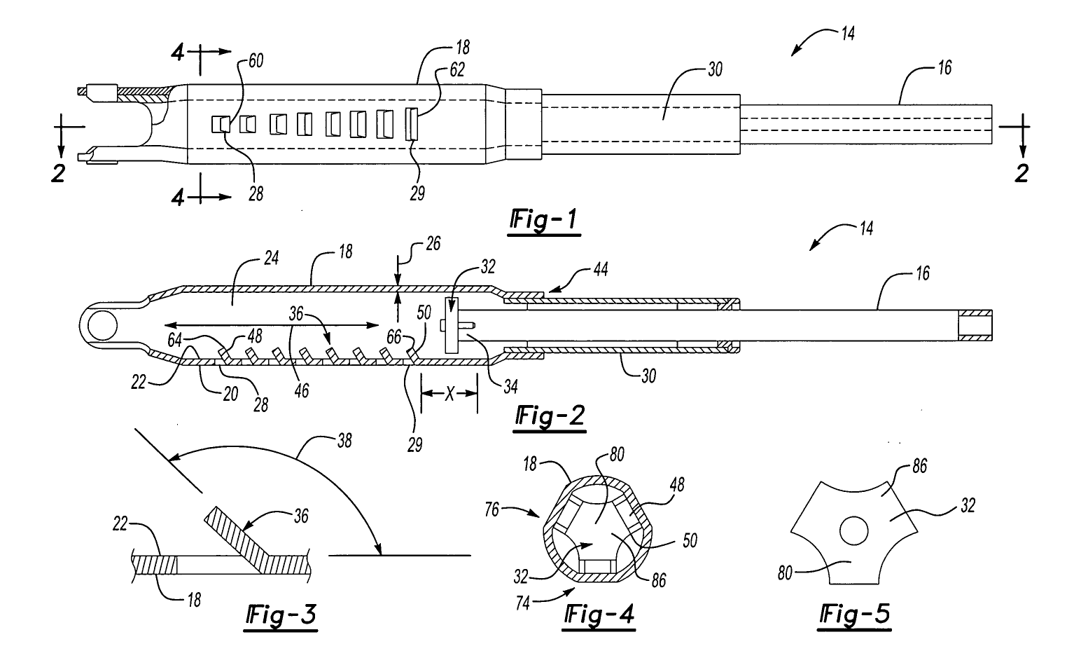

Referring now to FIGS. 1-5, in a first embodiment of the invention, an apparatus 14 includes a shaft member 16 having a first end 34. The apparatus also includes a sleeve member 18 having a first opening 44 and an inner surface 22 defining a cavity 24. The shaft member 16 is slidably received in the first opening 44. The first end 34 moves along a path 46 extending in the cavity 24. The apparatus also includes at least one deformable member 36 extending radially inwardly from the inner surface 22. The apparatus also includes an impact member 32 associated with the first end 34. The impact member 32 deforms the at least one deformable member 36 during movement of the first end 34 along the path 46 to absorb energy associated with movement of the shaft member 16.

The sleeve member includes an outer surface 20. A wall thickness 26 of the sleeve member 18 is defined between the outer surface 20 and the inner surface 22. The shaft member 16 and the sleeve member 18 are engaged in a slidable connection 30 relative to one another. A bearing can be disposed between the shaft member 16 and the sleeve member 18.

The at least one deformable member 36 of the first exemplary embodiment of the invention is integrally formed with respect to the sleeve member 18. The at least one deformable member 36 includes a plurality of deformable portions, such as portions 48, 50 spaced along the path 46. The portions 48, 50 are evenly spaced along the path 46, but could be randomly spaced as desired to control the energy absorbing characteristics of the deformable member 36. The portions 48, 50 are sized differently to absorb different amounts of energy. For example, the portions 48, 50 define different widths. The portions 48, 50 could be sized similarly with respect to one another. The portions 48, 50 are partially cut from the sleeve member 18, formed as flaps with corresponding apertures in the sleeve member 18, such as apertures 28, 29. Each portion 48, 50 includes one edge 60, 62, respectively, adjacent to the inner surface 22 and edges 64, 66 exposed in the cavity 24. The portions 48, 50 form an angle 38 with the inner surface 22. The angle 38 can be constant for all portions 48, 50, or can be varied to control the energy absorbing characteristics of the deformable member 36.

The first end 34 moves along the path 46 between first and second positions. The first position is shown in FIG. 2. The second position would be spaced further from the slidable connection 30 than the first position 29. The impact member 32 includes a plate 80 extending transversely with respect to the shaft member 16 from the first end 34. The plate 80 include a face portion 86 that engages the deformable member 36 during movement from the first position to the second position along the path 46. For example, the portions 48, 50 are bent about the edges 60, 62 respectively during engagement with the face portion 86 as the plate 80 moves to the second position. Energy is dissipated or absorbed by the bending or deformation of the portion 48, 50.

The structure and arrangement of the portions 48, 50 extending along the path 46 can be adjusted as desired to adjust the rate of energy is absorbed. The rate of energy absorbed can be constant or varied along the path 46. The rate of energy absorbed can be increased or decreased along the path 46. It may desirable to absorb more energy at the beginning of movement, such as when the face portion 86 engages the portion 50, and desirable to absorb less energy at the end of movement, such as when the face portion 86 engages the portion 48.

The at least one deformable member 36 includes a plurality of deformable members 36, 74, 76 angularly spaced from one another about the path 46. The plurality of deformable members 36, 74, 76 are evenly spaced from one another about the path 46. Each of the plurality of deformable members 36, 74, 76 includes a plurality of deformable portions, such as portions 48, 50 spaced along the path 46. The impact member 32 concurrently deforms all of the plurality of deformable members 36, 74, 76 during movement along the path.

A shape of the sleeve member 18 is maintained during deformation of the at least one deformable member 36. In some prior art methods of energy absorption, a costly, convoluted sleeve is used to absorb energy. The outer shape of the sleeve member 18 is maintained when the portions 48, 50 are deformed by the impact member 32.

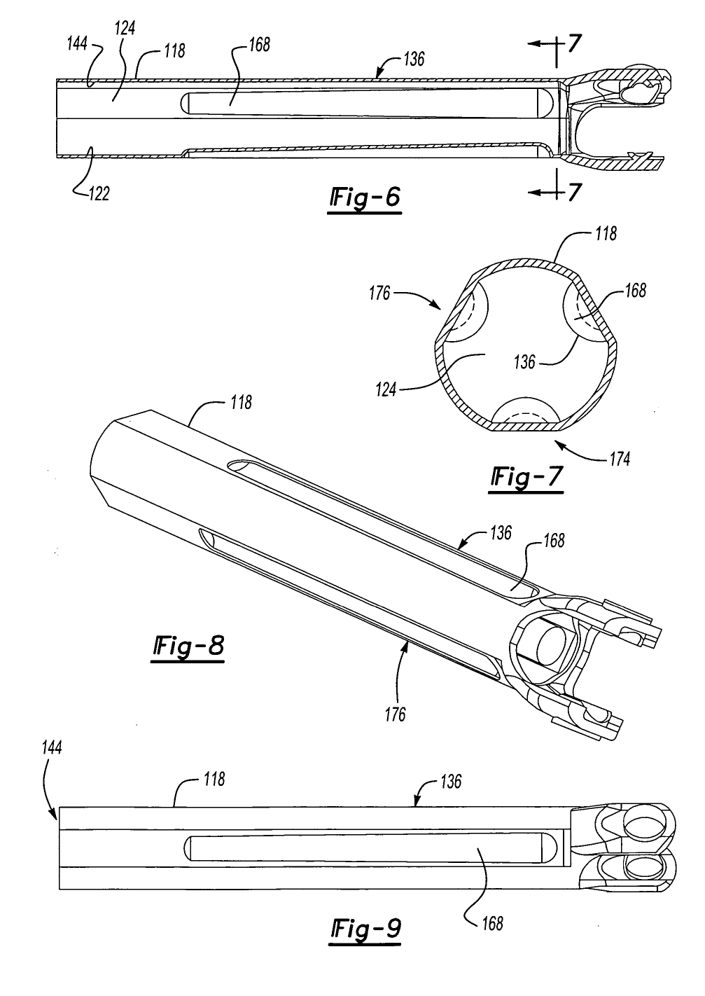

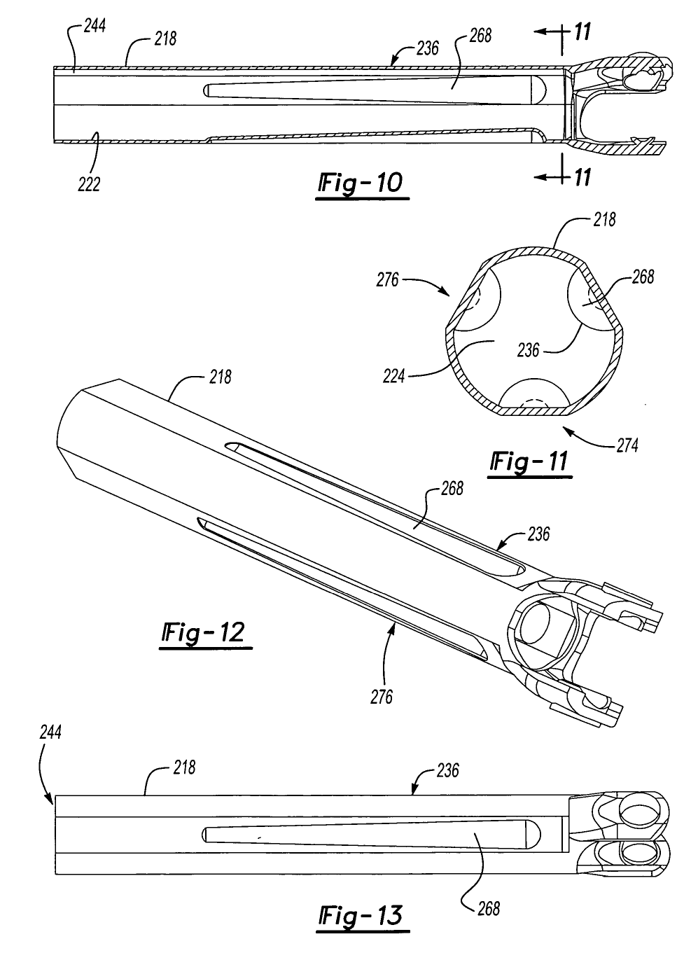

Referring now to FIGS. 6-9, in a second embodiment of the invention, a sleeve member 118 includes a first opening 144 and an inner surface 122 defining a cavity 124. A shaft member, such as a shaft member 16 shown in FIG. 1 or a shaft member 116 shown in FIG. 32, is slidably received in the first opening 144. The first end of the shaft member moves along a path extending in the cavity 124. The apparatus also includes at least one deformable member 136 extending radially inwardly from the inner surface 122. An impact member, such as impact member 32 shown in FIG. 1 or impact member 132 shown in FIG. 32, can be associated with the first end. The impact member deforms the at least one deformable member 136 during movement of the first end along the path to absorb energy associated with movement of the shaft member.

The at least one deformable member 136 includes at least one protuberance 168 having a length disposed along a path of travel of the shaft member, such path 46. The at least one protuberance 168 extends radially inwardly from the inner surface 122 into the cavity 124. The at least one protuberance 168 defines a variable width along the length. For example, the at least one protuberance 168 widens as the path extends from the opening 144. The shape of the at least one protuberance 168 can be constant along the path or can be varied as desired to control the energy absorbing characteristics of the deformable member 136.

The at least one deformable member 136 includes a plurality of deformable members 136, 174, 176 angularly spaced from one another about the path. The plurality of deformable members 136, 174, 176 are evenly spaced from one another about the path. The impact member concurrently deforms all of the plurality of deformable members 136, 174, 176 during movement along the path.

The at least one deformable member 236 includes at least one protuberance 268 having a length disposed along a path of travel of the shaft member, such path 46. The at least one protuberance 268 extends radially inwardly from the inner surface 222 into the cavity 224. The at least one protuberance 268 defines a variable width along the length. For example, the at least one protuberance 268 widens as the path extends from the opening 244. The shape of the at least one protuberance 268 can be constant along the path or can be varied as desired to control the energy absorbing characteristics of the deformable member 236.

The at least one deformable member 236 includes a plurality of deformable members 236, 274, 276 angularly spaced from one another about the path. The plurality of deformable members 236, 274, 276 are evenly spaced from one another about the path. The impact member concurrently deforms all of the plurality of deformable members 236, 274, 276 during movement along the path.

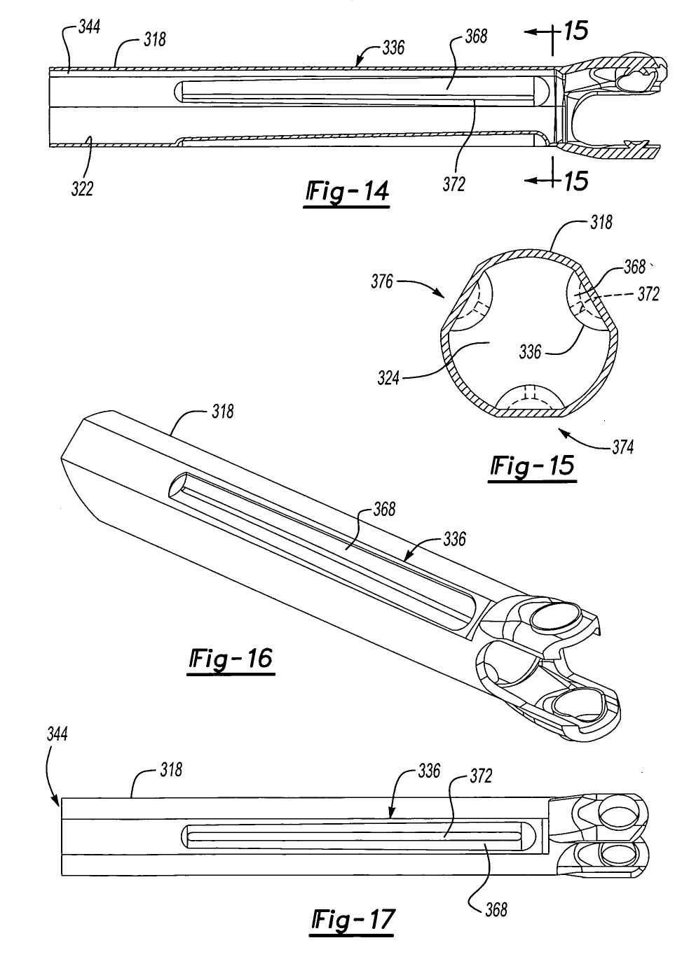

Referring now to FIGS. 14-17, in a fourth embodiment of the invention, a sleeve member 318 includes a first opening 344 and an inner surface 322 defining a cavity 324. A shaft member, such as a shaft member 16 shown in FIG. 1 or a shaft member 116 shown in FIG. 32, is slidably received in the first opening 344. The first end of the shaft member moves along a path extending in the cavity 324. The apparatus also includes at least one deformable member 336 extending radially inwardly from the inner surface 322. An impact member, such as impact member 32 shown in FIG. 1 or impact member 132 shown in FIG. 32, can be associated with the first end. The impact member deforms the at least one deformable member 336 during movement of the first end along the path to absorb energy associated with movement of the shaft member.

The at least one deformable member 336 includes at least one protuberance 368 having a length disposed along a path of travel of the shaft member, such path 46. The at least one protuberance 368 extends radially inwardly from the inner surface 322 into the cavity 324. The at least one protuberance 368 defines a variable width along the length. For example, the at least one protuberance 368 widens as the path extends from the opening 344. The shape of the at least one protuberance 368 can be constant along the path or can be varied as desired to control the energy absorbing characteristics of the deformable member 336. The at least one protuberance 368 includes a slit 372 extending along said length. The slit 372 defines a constant width along said length. However, in alternative embodiments of the invention, the slit 372 could define a variable width to control the energy absorbing characteristics of the deformable member 336.

The at least one deformable member 336 includes a plurality of deformable members 336, 374, 376 angularly spaced from one another about the path. The plurality of deformable members 336, 374, 376 are evenly spaced from one another about the path. The impact member concurrently deforms all of the plurality of deformable members 336, 374, 376 during movement along the path.

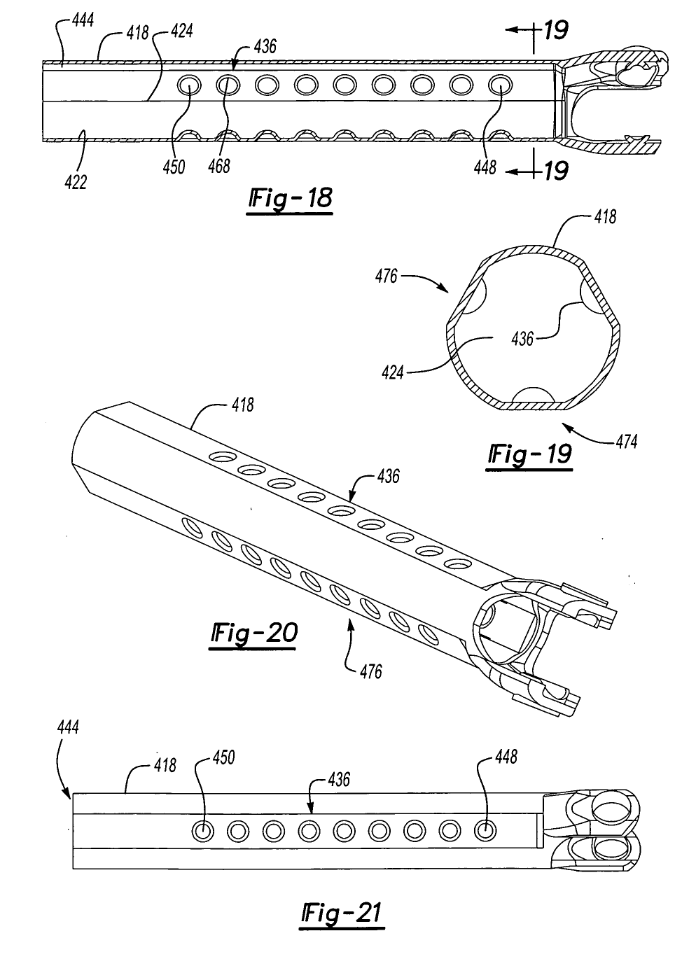

Referring now to FIGS. 18-21, in a fifth embodiment of the invention, a sleeve member 418 includes a first opening 444 and an inner surface 422 defining a cavity 424. A shaft member, such as a shaft member 16 shown in FIG. 1 or a shaft member 116 shown in FIG. 32, is slidably received in the first opening 444. The first end of the shaft member moves along a path extending in the cavity 424. The apparatus also includes at least one deformable member 436 extending radially inwardly from the inner surface 422. An impact member, such as impact member 32 shown in FIG. 1 or impact member 132 shown in FIG. 32, can be associated with the first end. The impact member deforms the at least one deformable member 436 during movement of the first end along the path to absorb energy associated with movement of the shaft member.

The at least one deformable member 436 includes at least one protuberance 468 having a length disposed along a path of travel of the shaft member, such path 46. The at least one protuberance 468 extends radially inwardly from the inner surface 422 into the cavity 424. The at least one protuberance 468 defines a variable width along the length. For example, the at least one protuberance 468 widens and narrows as the path extends from the opening 444. The shape of the at least one protuberance 468 can be constant along the path or can be varied as desired to control the energy absorbing characteristics of the deformable member 436.

The at least one deformable member 436 of the first exemplary embodiment of the invention is integrally formed with respect to the sleeve member 418. The at least one deformable member 436 includes a plurality of deformable protuberances, such as protuberances or portions 448, 450 spaced along the path. The portions 448, 450 are evenly spaced along the path, but could be randomly spaced as desired to control the energy absorbing characteristics of the deformable member 436. The portions 448, 450 are sized similarly to absorb similar amounts of energy. However, the portions 448, 450 could be sized differently with respect to one another.

The at least one deformable member 436 includes a plurality of deformable members 436, 474, 476 angularly spaced from one another about the path. The plurality of deformable members 436, 474, 476 are evenly spaced from one another about the path. The impact member concurrently deforms all of the plurality of deformable members 436, 474, 476 during movement along the path.

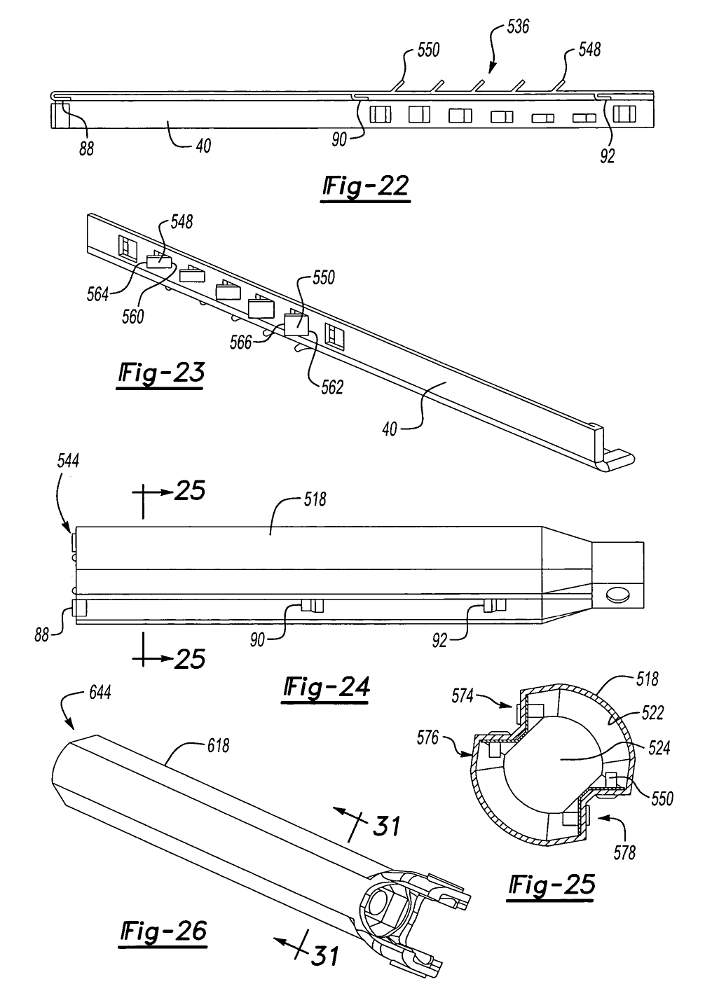

Referring now to FIGS. 22-25, in a sixth embodiment of the invention, a sleeve member 518 includes a first opening 544 and an inner surface 522 defining a cavity 524. A shaft member, such as a shaft member 16 shown in FIG. 1 or a shaft member 116 shown in FIG. 32, is slidably received in the first opening 544. The first end of the shaft member moves along a path extending in the cavity 524. The apparatus also includes at least one deformable member 536 extending radially inwardly from the inner surface 522. An impact member, such as impact member 32 shown in FIG. 1 or impact member 132 shown in FIG. 32, can be associated with the first end. The impact member deforms the at least one deformable member 536 during movement of the first end along the path to absorb energy associated with movement of the shaft member.

The at least one deformable member 536 includes a plate 40 received in the cavity 524 and at least one deformable portion 548, 550 projecting into the cavity 524 from the plate 40. The plate 40 is releasibly engageable with the sleeve member 518 with clips 88, 90, 92. The at least one deformable member 436 includes a plurality of deformable portions 548, 550 spaced along the path. The portions 548, 550 are evenly spaced along the path, but could be randomly spaced as desired to control the energy absorbing characteristics of the deformable member 536.

The portions 548, 550 are sized differently to absorb different amounts of energy. For example, the portions 548, 550 define different widths. The portions 548, 550 could be sized similarly with respect to one another. The portions 548, 550 are partially cut from the plate 40, formed as flaps with corresponding apertures in the plate 40. Each portion 548, 550 includes one edge 560, 562, respectively, adjacent to the inner surface 522 and edges 564, 566 exposed in the cavity 524. The portions 548, 550 form an angle with the inner surface 522. The angle can be constant for all portions 548, 550, or can be varied to control the energy absorbing characteristics of the deformable member 536.

The at least one deformable member 536 includes a plurality of deformable members 536, 574, 576, 578 angularly spaced from one another about the path. The plurality of deformable members 536, 574, 576, 578 are evenly spaced from one another about the path. The impact member concurrently deforms all of the plurality of deformable members 536, 574, 576, 578 during movement along the path.

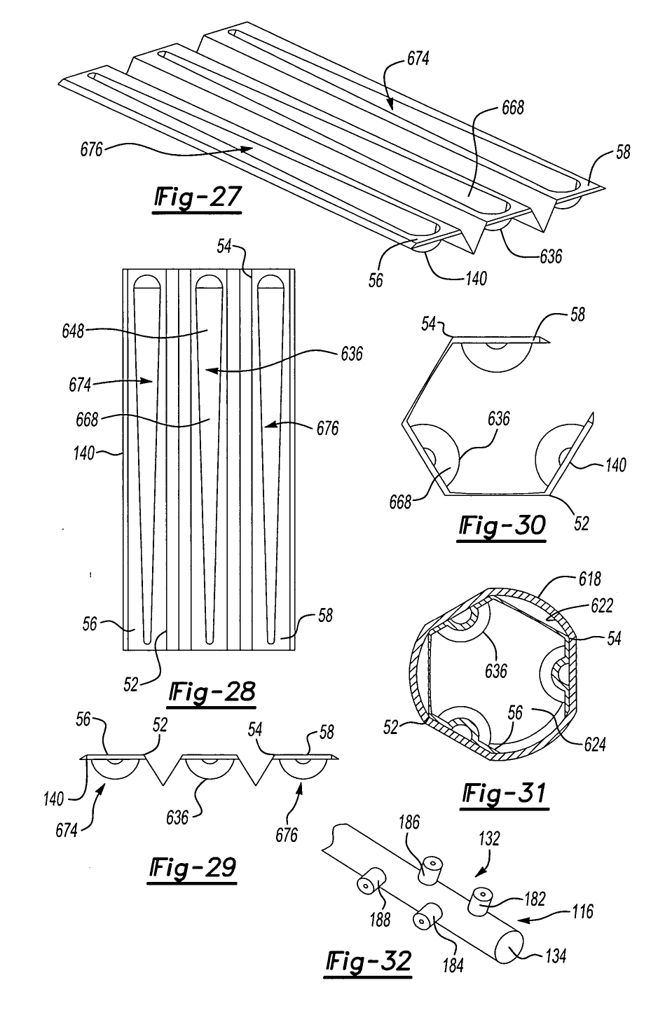

Referring now to FIGS. 26-31, in a seventh embodiment of the invention, a sleeve member 618 includes a first opening 644 and an inner surface 622 defining a cavity 624. A shaft member, such as a shaft member 16 shown in FIG. 1 or a shaft member 116 shown in FIG. 32, is slidably received in the first opening 644. The first end of the shaft member moves along a path extending in the cavity 624. The apparatus also includes at least one deformable member 636 extending radially inwardly from the inner surface 622. An impact member, such as impact member 32 shown in FIG. 1 or impact member 132 shown in FIG. 32, can be associated with the first end. The impact member deforms the at least one deformable member 636 during movement of the first end along the path to absorb energy associated with movement of the shaft member.

The at least one deformable member 636 includes at least one protuberance 668 having a length disposed along a path of travel of the shaft member, such path 46. The at least one protuberance 668 extends radially inwardly from the inner surface 622 into the cavity 624. The at least one protuberance 668 defines a variable width along the length. For example, the at least one protuberance 668 widens as the path extends from the opening 644. The shape of the at least one protuberance 668 can be constant along the path or can be varied as desired to control the energy absorbing characteristics of the deformable member 636.

The at least one deformable member 636 includes a plate 140 received in the cavity 624 and at least one deformable portion 648, 650 projecting into the cavity 624 from the plate 140. The plate 140 includes at least one folding edge 52, 54 defining first and second plate portions 56, 58 rotatably engaged with one another. Each of the plate portions can define a deformable member. For example, the at least one deformable member 636 includes a plurality of deformable members 636, 674, 676 angularly spaced from one another about the path. The plurality of deformable members 636, 674, 676 are evenly spaced from one another about the path. The impact member concurrently deforms all of the plurality of deformable members 636, 674, 676 during movement along the path.

Referring now to FIG. 32, in an eighth embodiment of the invention, an impact member 132 defines a plurality of impact surfaces that can contact different deformable members at different times. The impact member 132 includes at least one roller 182, 184, 186, 188 rotatably engaged with and extending transverse to a shaft member 116. The “leading edge” rollers 182, 184 extend transverse to one another and are axially offset with respect to one another along the shaft member 116. In operation, the roller 182 would engage a deformable member before the roller 184 would engage a deformable member. Also, the leading edge roller 182 and “trailing” roller 186 extend parallel to one another, are aligned with one another, and would engage the same deformable member sequentially.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus comprising:
a shaft member having a first end;
a sleeve member having a first opening and an inner surface defining a cavity wherein said shaft member is slidably received in said first opening and said first end moves along a path extending in said cavity;
at least one deformable member extending radially inwardly from said inner surface; and
an impact member associated with said first end to deform said at least one deformable member during movement of said first end along said path to absorb energy associated with movement of said shaft member.

2. The apparatus of claim 1 wherein said first end moves along said path between first and second positions and said at least one deformable member deforms at a predetermined rate during movement of said first end between said first and second positions.

3. The apparatus of claim 2 wherein said predetermined rate changes during movement of said first end between said first and second positions.

4. The apparatus of claim 3 wherein said predetermined rate increases during movement of said first end between said first and second positions.

5. The apparatus of claim 1 wherein said at least one deformable member is integrally formed with respect to said sleeve member.

6. The apparatus of claim 6 wherein a shape of said sleeve member is maintained during deformation of said at least one deformable member.

7. The apparatus of claim 1 wherein said at least one deformable member includes:
a plurality of deformable portions spaced along said path.

8. The apparatus of claim 7 wherein said plurality of deformable portions are evenly spaced along said path.

9. The apparatus of claim 7 wherein said wherein said plurality of deformable portions include at least first and second deformable portions operable to absorb different of amounts of energy.

10. The apparatus of claim 1 wherein said at least one deformable member includes a plate received in said cavity and at least one deformable portion projecting into said cavity from said plate.

11. The apparatus of claim 10 wherein said plate includes at least one folding edge defining first and second plate portions rotatably engaged with one another.

12. The apparatus of claim 1 wherein said at least one deformable member includes:
a plurality of flaps spaced along said path and having a first edge adjacent to said inner surface and at least one other edge exposed in said cavity.

13. The apparatus of claim 12 wherein said first edge of each of said plurality of flaps is integral with said sleeve member.

14. The apparatus of claim 12 wherein each of said plurality of flaps is rectangular.

15. The apparatus of claim 12 wherein at least two of said plurality of flaps are sized differently with respect to one another.

16. The apparatus of claim 15 wherein said at least two of said plurality of flaps define different widths.

17. The apparatus of claim 1 wherein said at least one deformable member includes:
at least one protuberance having a length disposed along said path and extending radially inwardly from said inner surface into said cavity.

18. The apparatus of claim 17 wherein said at least one protuberance defines a variable width along said length.

19. The apparatus of claim 17 wherein said at least one protuberance includes:
a slit extending along said length.

20. The apparatus of claim 17 wherein said slit defines a constant width along said length.

21. The apparatus of claim 17 wherein said at least one protuberance includes:
a plurality of protuberances spaced along said path.

22. The apparatus of claim 21 wherein each of said plurality of protuberances is sized similarly with respect to one another.

23. The apparatus of claim 21 wherein said plurality of protuberances are evenly spaced along said path.

24. The apparatus of claim 1 wherein said at least one deformable member includes:
a plurality of deformable members angularly spaced from one another about said path.

25. The apparatus of claim 24 wherein said plurality of deformable members are evenly spaced from one another about said path.

26. The apparatus of claim 24 wherein said plurality of deformable members include three deformable members.

27. The apparatus of claim 24 wherein said impact member concurrently deforms all of said plurality of deformable members.

28. The apparatus of claim 24 wherein each of said plurality of deformable members include:
a plurality of deformable portions spaced along said path.

29. The apparatus of claim 1 wherein said impact member includes:
a plate extending transversely with respect to said shaft member.

30. The apparatus of claim 1 wherein said impact member includes:
at least one roller rotatably engaged with and extending transverse to said shaft member.

31. The apparatus of claim 30 wherein said at least one roller includes:
first and second rollers.

32. The apparatus of claim 31 wherein said first and second rollers extend parallel to one another.

33. The apparatus of claim 32 wherein said first and second rollers are aligned along said shaft member.

34. The apparatus of claim 31 wherein said first and second rollers extend transverse to one another.

35. The apparatus of claim 34 wherein said first and second rollers are axially offset with respect to one another along said shaft member.
